(19) United States
(12) Patent Application Publication
(10) Pub. No.: US 2026/0025220 A1
(43) Pub. Date: Jan. 22, 2026

(54) METHOD AND SYSTEM FOR TRANSMITTING DATA OVER TRANSMISSION CHANNELS SHARED BY SECERALCOMMUNICATION PARTICIPANTS THROUGH TIME-DIVISION MULTIPLEXING

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/276,719

(22) Filed: Jul. 22, 2025

(30) Foreign Application Priority Data
Jul. 22, 2024 (DE) 10 2024 120 808.2

(51) Int. Cl. H04J 3/16

(52) U.S. Cl. CPC H04J 3/1682

(57) ABSTRACT

A method and a system for transmitting data over transmission channels shared by several communication participants through time-division multiplexing. Each of the communication participants is configured to dynamically assign messages which are to be sent over the transmission channels to the transmission channels and to assign messages which are to be sent over the transmission channels and which comprise data that is to be transmitted redundantly, to different transmission channels. The communication participants may be further configured to cooperatively determine, in a conflict resolution phase assigned to a time slot, for each of the transmission channels, which of the communication participants is authorized to transmit over the respective transmission channel in the time slot.

This nonprovisional application claims priority under 35 U.S.C. § 119 (a) to German Patent Application No. 10 2024 120 808.2, which was filed in Germany on Jul. 22, 2024, and which is herein incorporated by reference.

### FIELD OF THE INVENTION

The present invention relates to a method and a system for transmitting data over transmission channels shared by several communication participants through time-division multiplexing. In particular, the present invention relates to a mechanism for cooperatively determining the transmission authorization of individual communication participants.

### DESCRIPTION OF THE BACKGROUND ART

When transmission channels are shared through time-division multiplexing, collisions may occur if the communication participants transmit in an uncoordinated manner, which may disrupt the transmission of data over the transmission channels. Collisions may be avoided by settling for a deterministic transmission authorization in advance. However, such determinism may be accompanied by a waste of transmission resources if the transmission volume of the communication participants fluctuates over time.

### SUMMARY OF THE INVENTION

It is therefore an object of the present invention to provide a system may comprise several communication participants, wherein each of the communication participants may be configured to dynamically assign messages, which are to be sent over the transmission channels, to the transmission channels and to assign messages, which are to be sent over the transmission channels and which comprise data that is to be transmitted redundantly, to different transmission channels. The communication participants may be further configured to cooperatively determine, in a conflict resolution phase assigned to a time slot, for each of the transmission channels, which of the communication participants is authorized to transmit over the respective transmission channel in the time slot.

The dynamic assignment may be based on the resulting utilization of the transmission channels. In particular, the dynamically assigning may comprise that the communication participants, in successive assignment cycles synchronized across all communication participants, each comprising a number of conflict resolution phases which corresponds to the number of communication channels, go, in each assignment cycle, through all transmission channels and thereby assign to each transmission channel preferably (exactly) one message which in error-free operation is then sent over the transmission channel.

In this regard, the term “communication participant”, can refer to bus participants which can access one or more wired transmission channels bidirectionally via a bus interface. In this context, the term “transmission channel”, can refer to an electrical or optical line over which electrical or optical signals can be sent and received. Moreover, the term “dynamically assigning” can refer to an assignment which is carried out during operation, taking into account current and, where applicable, expected operating conditions for a specific time horizon, and thus evolves during operation.

Furthermore, the term “messages which comprise data that is to be transmitted redundantly”, can refer to messages the payload data of which may be used by the receiver to detect and/or correct transmission errors in the data. Moreover, the phrase “assigning messages . . . to . . . transmission channels”, can refer to scheduling messages for transmission over the respective transmission channels with the scheduled messages being then transmitted unless an event occurs that makes the transmission unnecessary, prevents the transmission, or complicates the transmission.

Furthermore, the term “time slot”, can refer to a time window the size of which is chosen such that a message can be transmitted over one of the transmission channels during the time slot. Moreover, the term “conflict resolution phase”, can refer to a phase in a time slot preceding a transmission phase in which, instead of transmitting user data, only signals and/or data are exchanged which serve to determine which of the communication participants is authorized to use the transmission channel in the transmission phase following the conflict resolution phase.

Furthermore, the phrase “cooperatively determining”, can refer to the conflict resolution being carried out with the active participation of all communication participants that have messages to be sent over the transmission channel and that communication participants waive the right to send a message in a specific time slot in favor of another communication participant if they can (currently) only assign less urgent messages to the transmission channel than the other communication participant.

The communication participants may further be configured to cooperatively determine which of the communication participants is authorized to transmit over the respective transmission channel in the time slot in that the communication participants assign urgency levels to the messages to be transmitted over the respective transmission channel, wherein one of the messages assigned to the respective transmission channel is prioritized on the basis of the urgency levels.

For example, each communication participant may determine which of the messages to be sent by the communication participant over the transmission channel has the (relatively) highest urgency level and communicate this urgency level to the other communication participants, wherein communication participants that communicate lower urgency levels than another communication participant make way for the latter.

If, for example, all communication participants except one communication participant report a same first urgency level and said communication participant reports a second urgency level that is higher than the first urgency level, said communication participant obtains the right to send the message to which the second urgency level is assigned in the current time slot.

If one of the messages which comprises data that is to be transmitted redundantly is prioritized, a new and higher urgency level compared to a previous urgency level may be assigned to each remaining message which comprises the data that is to be transmitted redundantly, unless the previous urgency level is already a highest urgency level.

For example, if three identical copies of the same data are to be transmitted in three different messages over three different transmission channels and the communication participant obtains the right to send one of the messages in the current time slot as a result of the conflict resolution, the urgency level of the remaining two messages is increased by the communication participant. This reduces the risk that the receiver must wait for a long time for the remaining messages.

The new urgency level may be higher than urgency levels of all messages which do not comprise any data that is to be transmitted redundantly.

That is, the urgency levels may, for example, be in a lower range or an upper range and the communication participants may be configured to initially assign urgency levels in the lower range to the messages and to reserve urgency levels in the upper range for messages which contain data that is to be transmitted redundantly.

The new urgency level may be higher than urgency levels of all messages which comprise data that is to be transmitted redundantly and is not also comprised in an already prioritized message.

That is, a priority level from the lower range may initially be assigned to all messages. If a message which comprises data that is to be transmitted redundantly is then prioritized, the remaining messages comprising the same data that is to be transmitted redundantly may be assigned, for example, the lowest priority level in the upper range.

If a message is assigned an urgency level in the upper range and the message is not prioritized during the time slot, it may be assigned a higher urgency level.

This increases the likelihood that messages the transmission of which has been delayed will be transmitted shortly.

There may be a temporal shift in the start of conflict resolution phases in different transmission channels.

The conflict resolution phases in different transmission channels may start and end such that they do not overlap.

Each time slot may start with a conflict resolution phase. Time slots relating to different transmission channels may start at different times, wherein a new time slot on one transmission channel may only begin when a time slot has already started on all other transmission channels. That is, the time slots may start and end such that within a time slot on one transmission channel, a time slot begins on every other transmission channel.

The transmission times at which the transmission channels may be used by the communication participants for transmitting messages may be divided into time slots of constant size.

A method may comprises dynamically assigning the messages to the transmission channels based on the resulting utilization of the transmission channels, wherein messages which comprise data that is to be transmitted redundantly may be, as far as possible, assigned to different transmission channels, and cooperatively determining a transmission authorization for each of the transmission channels, by the communication participants, based on the urgency levels of the messages assigned to the respective transmission channel.

The dynamically assigning may comprise that the communication participants, in successive assignment cycles synchronized across all communication participants, each comprising a number of conflict resolution phases which corresponds to the number of communication channels, go, in each assignment cycle, through all transmission channels and thereby assign to each transmission channel preferably (exactly) one message which in error-free operation is then sent over the transmission channel.

Notably, all features described in connection with the system may also be features of the method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a system for transmitting data over transmission channels shared by several communication participants through time-division multiplexing;

FIG. 2 shows messages that are to be sent over the transmission channels;

FIG. 3a shows a first conflict resolution phase;

FIG. 3b shows a second conflict resolution phase;

FIG. 3c shows a third conflict resolution phase;

FIG. 3d shows a fourth conflict resolution phase;

FIG. 3e shows a fifth conflict resolution phase;

FIG. 3f shows a sixth conflict resolution phase;

FIG. 4 shows transmission slots divided into time slots of constant size in which the transmission channels may be used by the communication participants to transmit messages; and

FIG. 5 shows a method for transmitting messages over transmission channels shared by several communication participants through time-division multiplexing.

### DETAILED DESCRIPTION

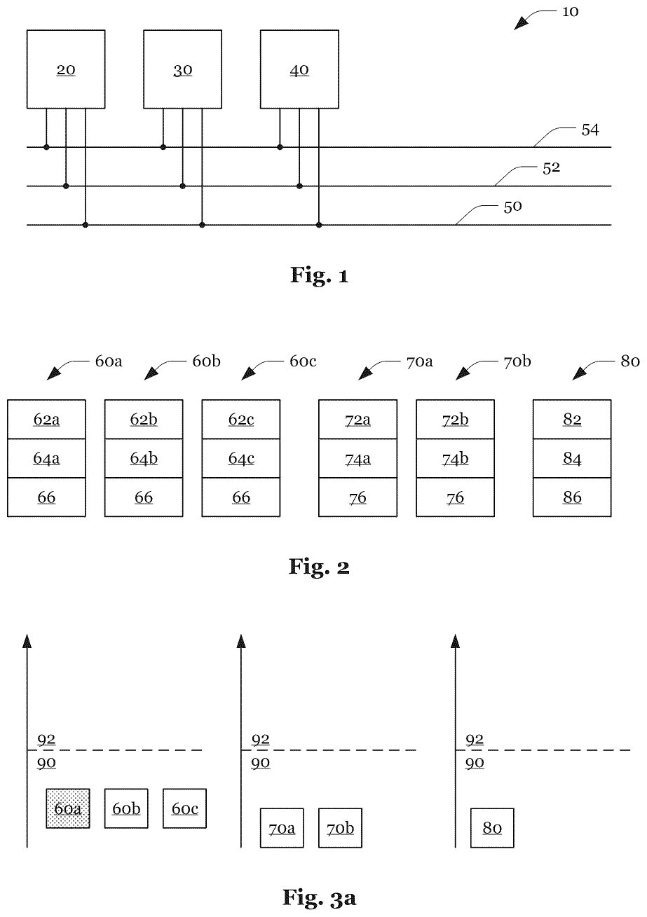

FIG. 1 shows a system 10 for transmitting data over transmission channels 50, 52, and 54 which are shared by several communication participants 20, 30 and 40 through time-division multiplexing. Due to the multi-channel connection of the communication participants 20, 30, and 40, data that is not to be transmitted redundantly can be transmitted on any of the transmission channels 50, 52 and 54, and data that is to be transmitted redundantly can be transmitted on different transmission channels 50, 52 and 54. The redundantly transmitted data may be verified at the receiver (possibly after forward error correction) and, if a deviation is found, rejected or submitted to a majority decision.

FIG. 2 shows first messages 60a, 60b, and 60c which are to be sent by the first communication participant 20 and which comprise first data 66 that is to be transmitted redundantly. Because the number of first messages 60a, 60b, and 60c corresponds to the number of available transmission channels 50, 52, and 54, each of the first messages 60a, 60b, and 60c may be assigned to a different one of the transmission channels 50, 52, and 54. FIG. 2 further shows second messages 70a and 70b which are to be sent by the second communication participant 30 and which comprise second data 76 that is to be transmitted redundantly. Because the number of second messages 70a and 70b is smaller than the number of available transmission channels 50, 52, and 54, each of the second messages 70a and 70b may be assigned to a different one of the transmission channels 50, 52, and 54. Furthermore, the resulting utilization of transmission channels 50, 52, and 54 may be taken into account in the assignment. FIG. 2 also shows a third message 80 which is to be sent by the third communication participant 40 and which comprises third data 86 that is not to be transmitted redundantly. The third message 80 may be freely assigned to one of the transmission channels 50, 52, and 54, wherein the resulting utilization of the transmission channels 50, 52, and 54 may be taken into account in the assignment.

The first messages 60a, 60b, and 60c may be derived from the first data 66 at the time of scheduling a data transmission in the first communication participant 20 in that a corresponding number of messages, in the present case three first messages 60a, 60b, and 60c, are generated in accordance with a redundancy depth individually defined for the first data 66. The second messages 70a and 70b may be derived from the second data 76 at the time of scheduling a data transmission in the second communication participant 30 in that a corresponding number of messages, in the present case two second messages 70a and 70b, are generated in accordance with a redundancy depth individually defined for the second data 76. To ensure that the association of the first messages 60a, 60b, and 60c with one another remains identifiable, individual identifications 62a, 62b, and 62c, for example in the form of numerical values, may be assigned to the first data 66, and the first messages 60a, 60b and 60c may be tagged with the individual identifications 62a, 62b, and 62c. To ensure that the association of the second messages 70a and 70b with one another remains identifiable, individual identifications 72a and 72b, for example in the form of numerical values, may be assigned to the second data 76, and the second messages 70a and 70b may be tagged with the individual identifications 72a and 72b. This allows associating the first messages 60a, 60b, and 60c and the second messages 70a and 70b to each other at the sender, but also at the receiver.

The messages 60a, 60b, 60c, 70a, 70b, and 80 may be generated and/or become available for transmission in the communication participants 20, 30, and 40 at fixed scheduled times or based on initiating events. When this happens, the second messages 70a and 70b and the third message 80 may not be pre-assigned to any of the transmission channels 50, 52, and 54. This allows for assigning the second messages 70a and 70b and the third message 80 to the transmission channels 50, 52, and 54 based on their utilization (and, in case of errors, their availability). The assigning of the messages 60a, 60b, 60c, 70a, 70b and 80 which are ready-to-be-sent at a given time may be carried out when the operation is error free in such a way that: the messages 60a, 60b, 60c, 70a, 70b, and 80 are (as far as possible) evenly distributed across all transmission channels 50, 52, and 54 (so that no time slots remain unused until all messages 60a, 60b, 60c, 70a, 70b, and 80 have been sent); messages, for example the first messages 60a, 60b, and 60c and the second messages 70a and 70b, which comprise data that is to be transmitted redundantly, e.g., the first data 66 and the second data 76, are sent over different transmission channels 50, 52, and 54; and the two aforementioned conditions are also met if, at any time during the transmission of messages 60a, 60b, 60c, 70a, 70b and 80, further messages are generated and/or become available for transmission.

If the operation is not error free:

If messages 60a, 60b, 60c, 70a, 70b, and 80 cannot be sent over one of the transmission channels 50, 52, or 54 due to an error, all messages still available for transmission are automatically redistributed to the remaining error-free transmission channels 50, 52, or 54, wherein redundant data, e.g., the first data 66 or the second data 76, may not be transmitted multiple times over the same transmission channel 50, 52, or 54; and

Utilization imbalances may occur.

As shown in FIG. 2, urgency levels 64a, 64b, 64c, 74a, 74b, and 84 may be assigned to the messages 60a, 60b, 60c, 70a, 70b, and 80 in addition to the identifications 62a, 62b, 62c, 72a, 72b and 82. The urgency levels 64a, 64b, 64c, 74a, 74b and 84 may be used to determine the temporal sending order when several messages 60a, 60b, 60c, 70a, 70b, and 80 are available to be sent. The urgency levels 64a, 64b, 64c, 74a, 74b, and 84 may be represented by numerical values from a specific numerical range, with a higher numerical value corresponding to greater urgency. The urgency of a message 60a, 60b, 60c, 70a, 70b, and 80 may be determined statically (for example, based on the content of the messages) or dynamically (for example based on requirements as to the time of delivery) during message generation. The numerical values may be used within a communication participant 20, 30, or 40 to determine the message(s) with the highest urgency among the ready-to-be-sent messages 60a, 60b, 60c, 70a, 70b, and 80 and to use this information to participate in conflict resolution regarding the transmission rights on a transmission channel 50, 52, or 54 in a time slot.

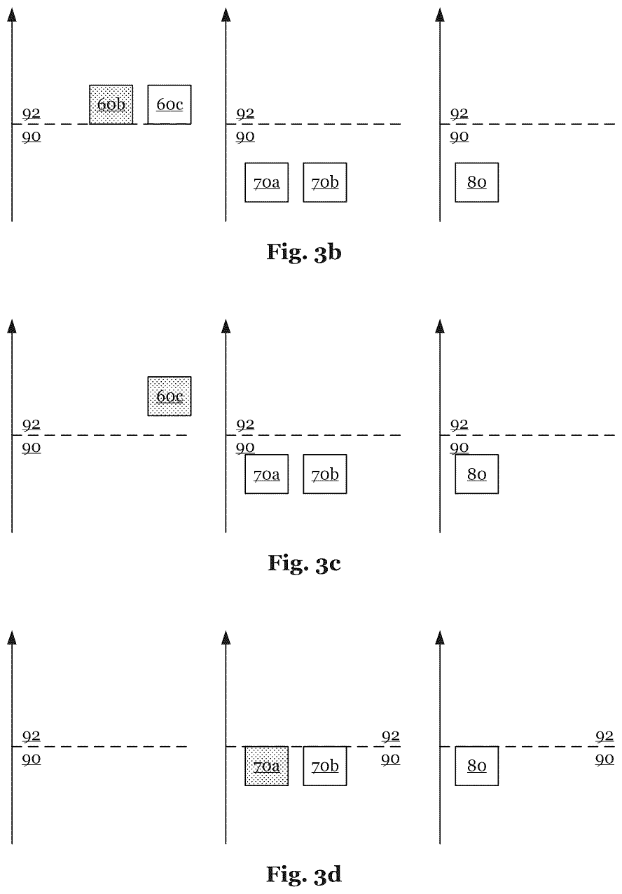

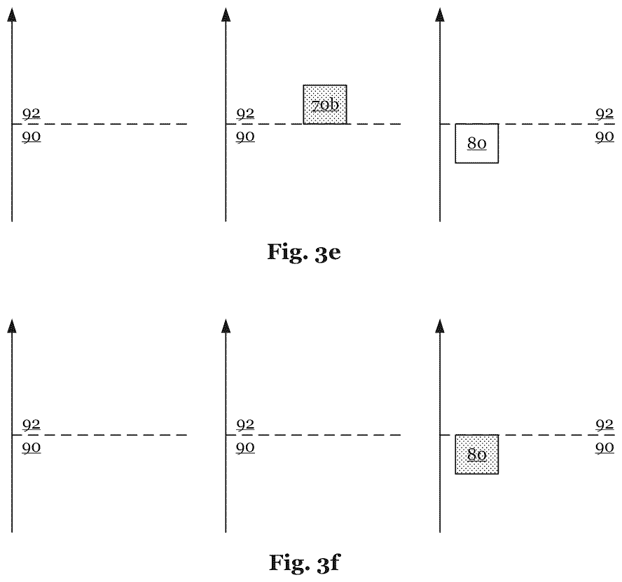

FIG. 3a shows a first exemplary conflict resolution phase regarding the transmission rights on the first transmission channel 50 in a current time slot. The ready-to-be-sent messages 60a, 60b, 60c, 70a, 70b, and 80 of the communication participants 20, 30, and 40 are arranged in a coordinate system grouped by communication participant with the positioning of the messages 60a, 60b, 60c, 70a, 70b, and 80 in the vertical direction reflecting their urgency. Because each communication participant 20, 30, and 40 has messages 60a, 60b, 60c, 70a, 70b, and 80 that are ready to be sent and the data 66, 76, and 86 have not already been sent over the first transmission channel 50, all communication participants 20, 30, and 40 participate in the first conflict resolution phase. If the data 76 had already been transmitted over the first transmission channel 50, the second communication participant 30 would not participate in the first conflict resolution phase because there would not be any messages that are ready to be sent and which comprise data that has not yet been transmitted over the first transmission channel 50.

To ensure that no collisions occur between the communication participants 20, 30, and 40 during the first conflict resolution phase, the communication participants 20, 30, and 40 may be synchronized to the beginning of the first conflict resolution phase and the communication participants 20, 30, and 40 may send a dominant signal on the first transmission channel 50 for a period of time which is derived from the urgency level with which the communication participants 20, 30, and 40 participate in the first conflict resolution phase. If a communication participant 20, 30 and 40 detects the dominant signal on the first transmission channel 50, which does not originate from it, it may interpret this as an indication that the urgency level reported by itself is lower than an urgency level reported by another communication participant 20, 30, and 40. If the highest urgency level is signaled simultaneously by two (or more) communication participants 20, 30, and 40, the conflict may be resolved by randomly extending the output of the dominant signal by the communication participants 20, 30, and 40.

Since during the first conflict resolution phase the urgency determines which of the communication participants 20, 30, and 40 is assigned the exclusive transmission right for the current time slot on the first transmission channel 50 and the first messages 60a, 60b and 60c have a higher urgency level than the second messages 70a and 70b and the third message 80, the first communication participant 20 prevails in the first conflict resolution phase. The first communication participant 20 may then mark the first message 60a as “in transmission” to avoid that the first message 60a is relied upon as to the participation in the conflict resolution with regard to transmission channels 52 and 54. If the transmission of the first message 60a fails due to an error, the first message 60a may be put back on the list of ready-to-be-sent messages 60a, 60b, 60c, 70a, 70b, and 80 so that the first message 60a can again participate in conflict resolution with regard to the transmission channels 50, 52, and 54, as the case may be. If the transmission of the first message 60a does not fail, the first message 60a may be deleted by the sender and the first communication participant 20 may mark the first data 66 as being transmitted over the first transmission channel 50, so that the first transmission channel 50 is not relied upon for transmitting the associated messages 60b and 60c. This ensures that the first communication participant 20 distributes messages, for example the first messages 60a, 60b and 60c, which comprise data that is to be transmitted redundantly, in this case the first data 66, across the transmission channels 50, 52 and 54 available for transmission. Furthermore, it can be ensured that data which is to be transmitted redundantly, such as the first data 66, is not transmitted multiple times in succession over the same transmission channel 50, 52, or 54.

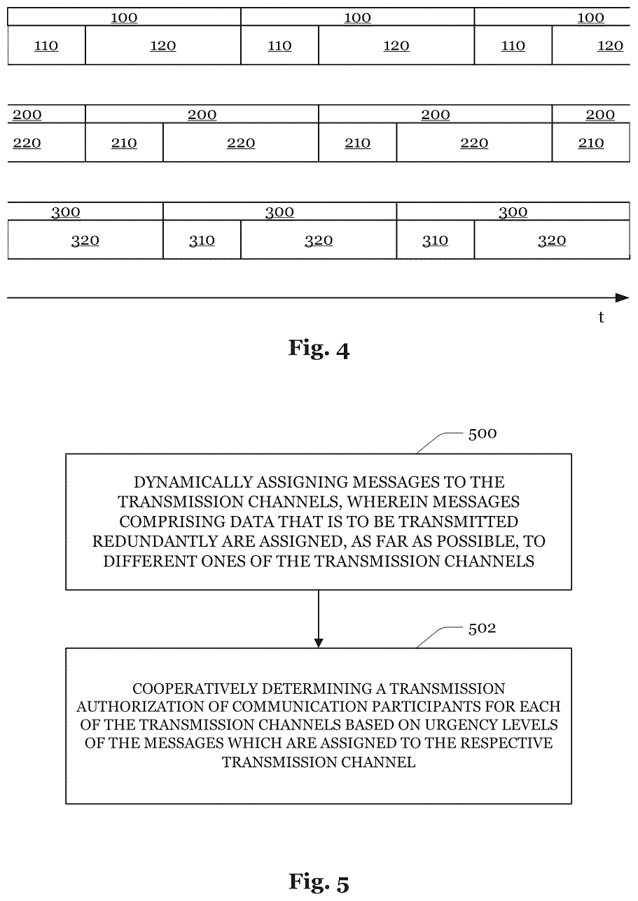

To prevent one of the messages 60a, 60b, 60c, 70a, 70b, and 80 from simultaneously prevailing in conflict resolutions with regard to the transmission rights on several of the transmission channels 50, 52, and 54 (and thus possibly being sent multiple times or causing a transmission slot to go by unused), it may be advantageous, as shown in FIG. 4, if the conflict resolution phases 110, 210, 310 do not take place simultaneously on the transmission channels 50, 52, and 54. To this end, it may be advantageous if the transmission channels 50, 52, and 54 are synchronized. The conflict resolution phases 110, 210, 310 of the transmission channels 50, 52, and 54 may then be arranged in such a way that they do not overlap in time. This may facilitate for the communication participants 20, 30 and 40 to timely exclude messages 60a, 60b, 60c, 70a, 70b, and 80, which have already successfully participated in one of the conflict resolution phases 110, 210, 310 and are “in transmission”, from further participation in conflict resolution phases 110, 210, 310 regarding other transmission channels 50, 52, and 54. Because each communication participant 20, 30, and 40 has read and write access to each of the transmission channels 50, 52, and 54, the communication participants 20, 30, and 40 have all the information for synchronization and the synchronization of the processes relating to the individual transmission channels 50, 52, and 54 may be carried out by the communication participants 20, 30, and 40 (without the assistance of another device).

If the conflict resolution phases 110, 210 and 310 on the transmission channels 50, 52 and 54 overlap (too much) in time, the third message 80, for example, may only be allowed to participate alternately in the conflict resolution phases 110, 210, and 310 in order to prevent it from being successful in two or more conflict resolution phases 110, 210, and 310 at the same time, which may cause two of the time slots 100, 200 and 300 or two of the transmission phases 120, 220, and 320 to be available for the transmission of the third message 80 or one of the transmission phases 120, 220, or 320 to be lost due to a double transmission. However, if the third message 80 were to participate only alternately in the conflict resolution phases 110, 210, and 310, it could happen that it is not successful in one of the conflict resolution phases 110, 210, and 310 regarding one of the transmission channels 50, 52, and 54, while it would have been successful with regard to one of the other conflict resolution phases 110, 210, and 310 in which it does not participate. This would change the sequence provided by the urgency levels and increase the risk of unequal utilization of the transmission channels 50, 52, and 54, especially if one of the transmission phases 120, 220, and 320 is not used due to non-participation. It may therefore be advantageous if the conflict resolution phases 110, 210, and 310 are offset in time from another such that they do not overlap in time across all transmission channels 50, 52, and 54 and the third message 80 can participate in all conflict resolution phases 110, 210, and 310. Time-offset and non-overlapping conflict resolution phases 110, 210, and 310 may thus reduce the risk that transmission phases 120, 220, and 320 remain unused if one of the messages 60a, 60b, 60c, 70a, 70b, and 80 is ready to be sent over one of the transmission channels 50, 52, and 54.

Load leveling may also be improved by further measures. For example, it could happen that one of the first messages 60b and 60c, for which the possible transmission channels 50, 52, and 54 are already reduced to two, i.e. the second transmission channel 52 and the third transmission channel 54, is always displaced by other newly ready-to-be-sent messages with a higher urgency, even though the newly ready-to-be-sent messages could also have been transmitted via the first transmission channel 50. In this case, the newly ready-to-be-sent messages would block the second transmission channel 52 and the third transmission channel 54, which are eligible for the first messages 60b and 60c, whereas the first transmission channel 50 would remain unused.

As further measures, the following rules may therefore be established with regard to the urgency levels 64a, 64b, 64c, 74a, 74b, and 84:

The numerical range in which the numerical values representing the urgency levels may lie may be divided into two sub-ranges. An upper range for higher urgency and a lower range for lower urgency.

A message that is ready-to-be-sent may be assigned an urgency from the lower range at the time it becomes available for sending. Within the lower range, urgencies may be handled application-specific. For example, urgencies may be static or change dynamically over time according to a certain (application-specific) rule.

If a message comprising data that is to be transmitted redundantly, has prevailed in conflict resolution, all messages carrying the same data may be assigned an urgency from the upper range.

If a message assigned an urgency from the upper range is not successful in conflict resolution, it may be assigned a higher urgency.

Messages assigned an urgency from the upper edge of the upper range may remain with that urgency even if they fail in a conflict resolution phase. If necessary, messages assigned an urgency from the upper edge of the upper range may be deleted if they are still unsuccessful after a certain number of conflict resolution phases.

As shown in FIG. 3b, after the first message 60a has prevailed in conflict resolution with regard to the transmission over the first transmission channel 50 as described in connection with FIG. 3a, the first messages 60b and 60c may be assigned urgency levels 62b and 62c, respectively, which are in the upper range 92. The messages 70a, 70b, and 80, on the other hand, may be assigned higher urgency levels 72a, 72c, and 82, which are still in the lower range 90 (alternatively, messages 70a, 70b, and 80 may keep their urgency levels 72a, 72c, and 82). The first messages 60b and 60c may therefore no longer be delayed by new messages that are ready-to-be-sent, since these are assigned urgencies that lie in the lower range 90. New messages that are ready-to-be-sent may therefore initially compete with each other according to application-specific determinations. By assigning urgency levels 62b and 62c, respectively, which are in the upper range 92, the risk may also be reduced that the remaining first messages 60b and 60c on the still possible transmission channels 52 and 54 are displaced by newly scheduled messages, even though the first transmission channel 50 may also be available for the newly scheduled messages.

After the first messages 60b have won the following conflict resolution phase 210, as shown in FIG. 3b, the remaining first message 60c may be assigned a higher urgency from the upper range 92, as can be seen from FIG. 3c. This may reduce the risk that a message that was first assigned an urgency from the upper range 92 can be “displaced” by a message that was later assigned an urgency from the upper range 92. This may maintain the priority order established by the conflict resolution phases 110, 210, and 310 carried out up to this point. The associated messages 60a, 60b, and 60c may thus be sent successively over the transmission channels 50, 52, and 54.

As shown in FIG. 3d, the second communication participant 30 and the third communication participant 40 participate in the next conflict resolution phase 110. Because the urgency levels reported by the participating communication participants 40 are the same, a random decision is made as to whether the second communication participant 30 is authorized to send. As shown in FIG. 3e, as a result of the prioritization of the second message 70a, the second message 70b may be assigned an urgency that lies in the upper range 92. Because the urgency assigned to the third message 80 is already at the upper edge of the lower range 90, it is not increased any further. This may ensure that the second message 70b prevails in the following conflict resolution phase 210. As shown in FIG. 3f, the third message 80 may then be sent in the following transmission phase 320.

FIG. 5 shows a method for transmitting the messages 60a, 60b, 60c, 70a, 70b and 80 over the transmission channels 50, 52 and 54. The method begins at step 500 with dynamically assigning the messages 60a, 60b, 60c, 70a, 70b and 80 to the transmission channels 50, 52 and 54, wherein the messages 60a, 60b, 60c, 70a, and 70b comprising the data 66 and 76 that is to be transmitted redundantly, are assigned to different ones of the transmission channels 50, 52 and 54. The method ends at step 502 with cooperatively determining a transmission authorization of the communication participants 20, 30, and 40 for each of the transmission channels 50, 52, and 54 based on urgency levels 64a, 64b, 64c, 74a, 74b, and 84 of the messages 60a, 60b, 60c, 70a, 70b, and 80 assigned to the respective transmission channel 50, 52, and 54.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for transmitting data over transmission channels shared by several communication participants through time-division multiplexing, wherein at least two of the communication participants is configured to dynamically assign messages that are to be sent over the transmission channels to the transmission channels, wherein at least two of the communication participants is further configured to assign messages that are to be sent over the transmission channels and which comprise data that is to be transmitted redundantly, to different ones of the transmission channels, and wherein the communication participants are further configured to cooperatively determine, for each of the transmission channels in a conflict resolution phase that is assigned to a time slot, which of the communication participants is authorized to transmit over a respective transmission channel in the time slot.

2. The system according to claim 1, wherein the communication participants are further configured to cooperatively determine which of the communication participants is authorized to transmit over the respective transmission channel in the time slot in that the communication participants assign urgency levels to the messages that are to be transmitted over the respective transmission channel, and wherein one of the messages assigned to a respective transmission channel is prioritized based on the urgency levels of the messages assigned to the respective transmission channel.

3. The system according to claim 2, wherein, if one of the messages which comprises data that is to be transmitted redundantly is prioritized, a new and higher urgency level, compared to a previous urgency level, is assigned to each remaining message which comprises the data that is to be transmitted redundantly, unless the previous urgency level is already a highest urgency level.

4. The system according to claim 3, wherein the new urgency level is higher than urgency levels of all messages that do not comprise any data that is to be transmitted redundantly, and wherein the new urgency level is higher than urgency levels of all messages which comprise data that is to be transmitted redundantly and that is not also comprised in an already prioritized message.

5. The system according to claim 4, wherein the urgency levels are in a lower range or an upper range, and wherein the communication participants are configured to initially assign urgency levels from the lower range to the messages and to reserve urgency levels from the upper range for messages which comprise data that is to be transmitted redundantly.

6. The system according to claim 5, wherein one of the messages is assigned a higher urgency level if said message is assigned an urgency level from the upper range and the message is not prioritized during the time slot.

7. The system according to claim 1, wherein there is a temporal shift in the start of conflict resolution phases in different transmission channels.

8. The system according to claim 1, wherein conflict resolution phases in different transmission channels do not overlap.

9. The system according to claim 1, wherein transmission times at which the transmission channels can be used by the communication participants for transmitting messages, are divided into time slots of constant size.

10. A method for transmitting messages over transmission channels shared by several communication participants through time-division multiplexing, the method comprising:
dynamically assigning the messages to the transmission channels, wherein messages comprising data that is to be transmitted redundantly are assigned, as far as possible, to different ones of the transmission channels; and
cooperatively determining a transmission authorization of the communication participants for each of the transmission channels based on urgency levels of the messages that are assigned to the respective transmission channel.

11. The method according to claim 10, wherein the dynamically assigning comprises that the communication participants, in successive assignment cycles synchronized across all communication participants, each comprising a number of conflict resolution phases which correspond to the number of communication channels, go, in each assignment cycle, through all transmission channels and thereby assign to each transmission channel one message which in error-free operation is then sent over the transmission channel.
